(19) United States
(12) Patent Application Publication
(10) Pub. No.: US 2019/0095468 A1
(43) Pub. Date: Mar. 28, 2019

(54) METHOD AND SYSTEM FOR IDENTIFYING AN INDIVIDUAL IN A DIGITAL IMAGE DISPLAYED ON A SCREEN

(71) Applicant: AVIGILON PATENT HOLDING 1 CORPORATION, Vancouver (CA)

(72) Inventors: Charles A. Myers, La Jolla, CA (US); Alex Shah, San Diego, CA (US)

(21) Appl. No.: 16/113,921

(22) Filed: Aug. 27, 2018

Related U.S. Application Data
(63) Continuation of application No. 14/033,379, filed on Sep. 20, 2013, now abandoned.
Application No. 14/033,379 is a continuation of application No. 13/252,139, filed on Oct. 3, 2011, now abandoned.
Application No. 13/252,139 is a continuation-in-part of application No. 12/341,318, filed on Dec. 22, 2008, now Pat. No. 8,369,570.
Application No. 12/341,318 is a continuation-in-part of application No. 11/534,667, filed on Sep. 24, 2006, now Pat. No. 7,450,740.
(60) Provisional application No. 61/389,267, filed on Oct. 3, 2010.
(60) Provisional application No. 61/016,800, filed on Dec. 26, 2007.

(51) Int. Cl. G06F 17/30; G06K 9/00

(52) U.S. Cl. CPC G06F 17/30271; G06K 9/00268; G06K 9/00288

(57) ABSTRACT

A system and method for identifying an image of an individual by touching a screen in a photo is disclosed herein. A feature vector of an individual is used to analyze other photos on a database or social networking website such as FACEBOOK® to determine if an image of the individual is present in a photo of the set of photos. Photos having an image of the individual are tagged preferably by listing a URL or URI for each of the photos in a database.

### CROSS REFERENCE TO RELATED APPLICATIONS

The Present application is a continuation application of U.S. patent application Ser. No. 14/033,379, filed on Sep. 20, 2013; which is a continuation application of U.S. patent application Ser. No. 13/252,139, filed on Oct. 3, 2011; which claims priority to U.S. Provisional Patent No. 61/389,267, filed on Oct. 3, 2010, and is also a continuation-in-part application of U.S. patent application Ser. No. 12/341,318, filed on Dec. 22, 2008, now U.S. Pat. No. 8,369,570 issued Feb. 5, 2013; which claims priority to U.S. Provisional Patent No. 61/016,800, filed on Dec. 26, 2007, and is also a continuation-in-part application of U.S. patent application Ser. No. 11/534,667, filed on Sep. 24, 2006, now U.S. Pat. No. 7,450,740, issued Nov. 11, 2008, all of which are hereby incorporated by reference in their entireties.

### BACKGROUND OF THE INVENTION

### Field of the Invention

The present invention relates to touch image searching.

### Description of the Related Art

As cloud computing becomes more relevant and includes images, identify personal, information and is accessible to wireless devices mobile devices computer terminals, networked devices, cellular telephones, and tablet computers, a user must be allowed to more easily interact with these devices and for search for content within an image. As the resolution of all of the aforementioned devices becomes more accurate and with higher resolution, the ability to correctly identify an individual simply by touching on their face or pointing a pointing device be it light emitting RF stylists were the human touch becomes more highly relevant.

As users interact with visual displays, whether it be on mobile devices tablet computers or televisions, users to desire to “drill down” into the information of what they are seeing on the display. This invention is directed at the ability for a viewer of all of any and all of this information to identify individuals or relative information about those individuals simply by pointing a device or touching the screen to allow access to either metadata, wiki profiles, social network profiles, web-based information or private cloud-based information or local device information particularly relevant to the individual or individuals of similar appearance that a user wishes to identify.

### BRIEF SUMMARY OF THE INVENTION

Embodiments of the invention relate to the field of touch search and more specifically identifying individuals within a video frame or image digital image frame presented either on a mobile device a computer screen television or other visual display. The invention allows for the identification of a person or persons from within a digital image or video, in which by touching on or clicking or performing a mouse over of that particular individual allows for other images of that individual or similar individuals either twin in appearance or exactly the original individual to be identified from a database of images feature vectors indices or other forms of image identification.

The above deficiencies and need associated with user interfaces for viewing digital images or video can be reduced or eliminated by the search techniques. The search techniques allow for a user to avoid searching metadata, i.e. user input names addresses IDs or other written information regarding the identity of a person other than their image.

Having briefly described the present invention, the above and further objects, features and advantages thereof will be recognized by those skilled in the pertinent art from the following detailed description of the invention when taken in conjunction with the accompanying drawings.

### BRIEF DESCRIPTION OF THE SEVERAL VIEWS OF THE DRAWINGS

FIG. 1 is an illustration of a face browser aspect of the present invention.

FIG. 2 is an illustration of a video search application aspect of the present invention.

FIG. 3 is an illustration of a face finder aspect of the present invention.

FIG. 4 is an illustration of a touch search aspect of the present invention.

### DETAILED DESCRIPTION OF THE INVENTION

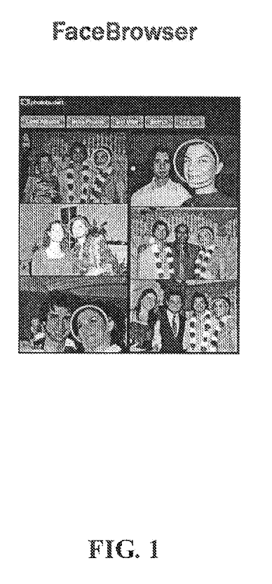

A face browser aspect of the present invention is shown in FIG. 1. Photo-tagging, search applications and touch-based searching are included in this aspect of the invention. A layer of intelligence is added to existing photo sites such as PHOTOBUCKET® and MYSPACE® sites. The present invention finds all faces within a digital album and indexes them. A user touches on any face and photos are sorted showing additional images of that person. For IPAD®, PHONE®, ANDROID®, and MYSPACE and PHOTOBUCKET.

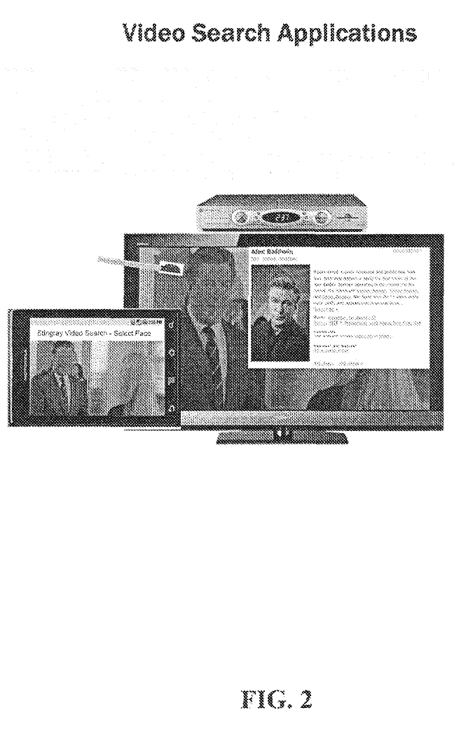

A video search application of the present invention is shown in FIG. 2. Several video search applications can be enabled by FaceDouble's technology platform including: Actor Search—Retrieve information about an actor including other films starting that actor by selecting the actor's face; and Athlete Search—Retrieve information about an athlete including that athlete's performance statistics by selecting the athlete's face. One example is an actor search wherein information pertaining to that actor is retrieved and presented on a display. Another example is an athlete search wherein information pertaining to that actor is retrieved and presented on a display.

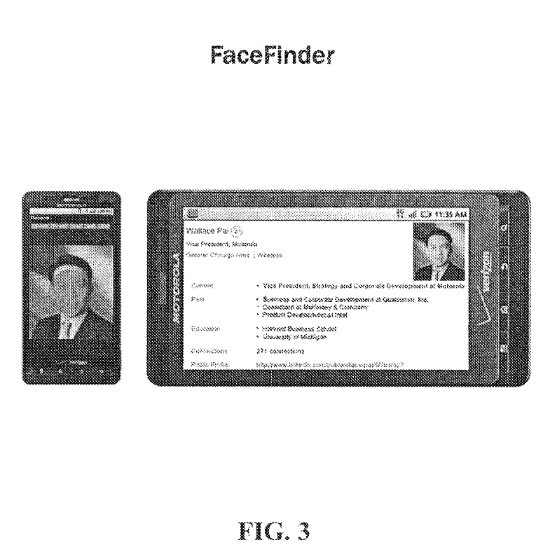

A face finder aspect of the present invention is shown in FIG. 3. A user can photograph a person and search for that person on social networks. It is an identity search application. It enables users to take a picture of an individual and then search for that individual's profile on social networks. Applicant is currently in discussions with MYSPACE to launch this application. Next logical step for mobile applications like GOOGLE goggles.

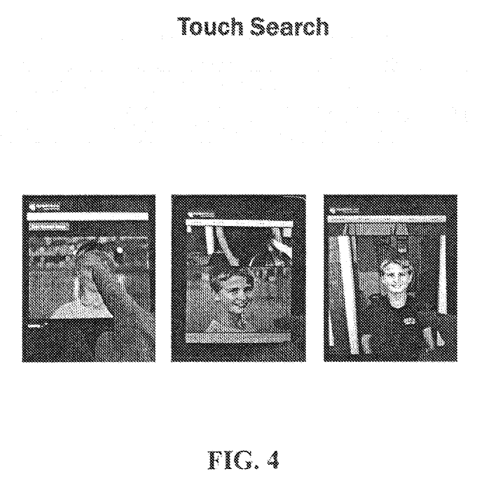

A touch search aspect of the present invention is shown in FIG. 4. A user can touch a face on a display screen which will search for that individual in a database or on a social network and return the results. It provides a unique experience not found on other search applications. It allows users of touch sensitive devices to search faces in digital images and videos simply by touching the face of the person in the mage. Touch search capability is integrated into the FaceBrowser application and can be applied to any of FaceDouble's other applications.

In some embodiments, including those involving watching a video or a movie on a display such as a TV a movie theater screen a portable computer tablet computer or a mobile phone or other device, performing a search for an individual simply by touching or pointing to a person on the display allows the viewer to access information from a locally attached storage device, over a network, or to a cloud-based storage center. In its simplest embodiment a system detects the touch of the face of an actor while watching the movie, the system identifies the image through a facial detection technique, the system identifies the image through facial recognition techniques, feature vector analysis, wavelet analysis, or other image identification algorithms. The system then returns the identification and any associated metadata with the person information associated with the received image. The returned information can include social profile information personal information such as hair color eye color address favorite foods likes dislikes, current dating patterns, information relating to familial relationships and/or dating relationships, or background information such as financial data or personal business relationship data.

In some embodiments, the system can detect the identification of an individual within an image a movie or a video or film, thereby allowing a user to vote on their selection of that image simply by pointing a pointer or touching the image of selected individuals on the screen. An example of this system, contained in the: set-top box; television signal decoder; or network attached controller; or storage device: allows that while broadcasting an episode of the television show, the system, would allow viewers to point to, with a pointing device, mouse, remote control unit, or touch the screen, identifying an individual that may be their favorite actor in a particular scene. The system could accept these as votes, could accept this is marketing information, or can accept this as input to a system that will return voting data relationship data, or other metadata that may be associated with that individual's character and or non-character persona.

In some embodiments, a method or system, whereby the system detects input from a user of the device and receives that input, the input being the identification of an individual in a photograph video film or movie being displayed on a mobile device, such as a smart phone or tablet computer or other mobile device, receiving that information, identifying an individual, where that individual may be contained in a private database of images or videos within a private network or cloud. Whereby the system allows receiving input to identify a number of individuals where the individual for example as that of a specific child or family member within the family photo album. An album can be defined as any storage database of images that contains images of a group, a group that could be immediate family, a school group, a social group, a peer group, a sports team.

In some embodiments, a system or method of allowing a viewer of a sporting event television, television show, or movie, to identify a player or actor, simply by a touching a screen or pointing to the desired person. The system will identify and return information about that athlete's performance skills records were statistics for that athletic event broadcast or fill associated with that athlete's history or future performance.

In some embodiments the system uses tag list image search. Tag list image search anticipates searching for images metadata associated with those images personal information associated with those images that do not require input of metadata. The input data is solely the input of an image or a unique identifier retrieved and created from that image that allows the system to return similar images of that person or simile or similarly appearing individuals and or personal information, social profile information, metadata or relevant information associated with that and the jewel.

A more detailed description of generating feature vectors is disclosed in Shah, et al., U.S. Pat. No. 7,450,740, for an Image Classification and Information Retrieval over Wireless Digital Networks and the Internet, which is hereby incorporated by reference in its entirety.

Another example of techniques for image searching used in the present invention are found in Shah, et al., U.S. Pat. No. 7,587,070 for an Image Classification And Information Retrieval Over Wireless Digital Networks And The Internet, which is hereby incorporated by reference in its entirety.

Another example of techniques for image searching used in the present invention are found in Myers, et al., U.S. Patent Publication Number 2009-0060289 for a Digital Image Search System And Method, which is hereby incorporated by reference in its entirety.

Another example of techniques for image searching used in the present invention are found in Shah, et al., U.S. Pat. No. 7,599,527 for a Digital Image Search System And Method, which is hereby incorporated by reference in its entirety.

Another example of techniques for image searching used in the present invention are found in Myers, et al., U.S. Patent Publication Number 2010-0235400 for a Method And System For Attaching A Metatag To A Digital Image, which is hereby incorporated by reference in its entirety.

Another example of techniques for image searching used in the present invention are found in Shah, et al., U.S. patent application Ser. No. 12/948,709, filed on Nov. 17, 2010, for a Method And System For Attaching A Metatag To A Digital Image, which is hereby incorporated by reference in its entirety.

From the foregoing it is believed that those skilled in the pertinent art will recognize the meritorious advancement of this invention and will readily understand that while the present invention has been described in association with a preferred embodiment thereof, and other embodiments illustrated in the accompanying drawings, numerous changes modification and substitutions of equivalents may be made therein without departing from the spirit and scope of this invention which is intended to be unlimited by the foregoing except as may appear in the following appended claim.

Therefore, the embodiments of the invention in which an exclusive property or privilege is claimed are defined in the following appended claims.

1. (canceled)

2. A method comprising:
broadcasting a video over a network;
receiving the video at a device that includes a touch screen display;
displaying the video on the touch screen display;
receiving user input via the touch screen display while the video is being broadcasted, the user input identifying a region on the display corresponding to a facial image to be analyzed;
analyzing the facial image to obtain a feature vector;
comparing the feature vector to a plurality of feature vectors stored in a database to obtain at least one comparison result that identifies a single individual across a plurality of images; and
employing the comparison result to enable information about the single individual to be collected from a plurality of different storages; and
presenting the collected information on the touch screen display.

3. The method of claim 2 wherein the video is a pre-recorded video.

4. The method of claim 3 wherein the pre-recorded video is a movie.

5. The method of claim 2 wherein the device is a mobile phone or tablet computer.

6. The method of claim 2 wherein the different storages include a plurality of Internet-accessible media content repositories.

7. The method of claim 6 wherein each of the plurality of Internet-accessible media content repositories is maintained by a different company.

8. A method comprising:
providing pre-recorded video over a network;
receiving the pre-recorded video at a device that includes a touch screen display;
displaying the pre-recorded video on the touch screen display;
receiving user input via the touch screen display while the pre-recorded video is being played, the user input identifying a region on the display corresponding to a facial image to be analyzed;
analyzing the facial image to obtain a feature vector;
comparing the feature vector to a plurality of feature vectors stored in a database to obtain at least one comparison result that identifies a single individual across a plurality of images; and
employing the comparison result to enable information about the single individual to be collected from a plurality of different storages; and
presenting the collected information on the touch screen display.

9. The method of claim 8 wherein the pre-recorded video is a movie.

10. The method of claim 8 wherein the device is a mobile phone or tablet computer.

11. The method of claim 8 wherein the different storages include a plurality of Internet-accessible media content repositories.

12. The method of claim 11 wherein each of the plurality of Internet-accessible media content repositories is maintained by a different company.
